(19) United States
(12) Patent Application Publication
(10) Pub. No.: US 2014/0243421 A1
(43) Pub. Date: Aug. 28, 2014

(54) BIOLOGICALLY ACTIVE COMPOSITIONS CONTAINING PHENOLIC RESIDUE

(71) Applicant: Yoram Tsivion, Caesarea (IL)

(72) Inventor: Yoram Tsivion, Caesarea (IL)

(21) Appl. No.: 14/267,436

(22) Filed: May 1, 2014

Related U.S. Application Data
(63) Continuation of application No. PCT/IB2012/056050, filed on Oct. 31, 2012.
(60) Provisional application No. 61/555,011, filed on Nov. 3, 2011.
(60) Provisional application No. 61/563,557, filed on Nov. 24, 2011.

(51) Int. Cl. A01N 25/32; A01N 35/04

(52) U.S. Cl. CPC A01N 25/32; A01N 35/04
USPC 514/699

(57) ABSTRACT

A composition for controlling pests. The composition includes an aqueous mixture of at least one phenolic aldehyde and a bisulfite salt with a suitable surfactant and a sufficient amount of the bisulfite salt to solubilize the aldehyde(s). A stable apparent solution is formed.

### CROSS REFERENCE TO RELATED APPLICATIONS

This application is a national stage entry of International Application PCT/IB201 2/056,050, entitled “Biologically active compositions containing phenolic residue”, filed Oct. 31, 2012; and claims priority from U.S. provisional patent application 61/555,011, filed Nov. 3, 2011 and U.S. provisional patent applications 61/563,557, filed Nov. 24, 2011 the entire contents of which are incorporated herein by reference.

### FIELD OF THE INVENTION

The present invention is in the field of plant protection and nutrition of biological systems. More specifically, compositions for the control of pests are disclosed.

In the agricultural practice, synthetic toxic agents are used to reduce the population of harmful pests such as insects in crops. Typical chemical agents employed in such practice are organo-phosphorous and carbamate compounds. The toxicity associated with such substances is often considered harmful to the environment and to the consumers of food products produced from the crops. To facilitate cultivation of crops and yet keep the harmful effect low, chemical agents having reduced toxicity and reduced persistence have been introduced to control pests. For example, the application of plant essential oils to combat beetles in packages of food products are disclosed in US patent application publication US 2003/0091661A1.

Several secondary plant metabolites, which are also typically constituents of hydrophobic essential oils having a phenolic residue, have been shown to perform as pest controlling agents. GB patent application 2415381 A deals with the control of insects by vanillin solubilized in water. GB patent application 2450082A relates to compositions consisting of salicylaldehyde and other components that are effective together as nematode control agents. The present invention deals with means for modifying and/or enhancing the use of such beneficial materials active in the control of invertebrate pests and/or diseases.

### SUMMARY

According to embodiments of one aspect of the invention there is provided a composition for controlling pests including an aqueous mixture of at least one phenolic aldehyde and a bisulfite salt with a suitable surfactant, there being a sufficient amount of the bisulfite salt to solubilize the at least one aldehyde, wherein a stable apparent solution is formed. In some embodiments, the composition further includes a heavy metal ion, wherein the apparent composition includes a chelated metal ion. In some embodiments, the chelated metal ion is judged by a red tint of the apparent solution.

According to embodiments of another aspect of the invention there is provided a use a composition including an aqueous mixture of phenolic aldehydes and a bisulfite compound, the use being for controlling pests. In some embodiments, the aldehyde is vanillin. In some embodiments, the aldehyde is salicylaldehyde.

According to embodiments of another aspect of the invention there is provided a method of solubilizing hydrophobic pesticides having one or more carbonyl groups including adding bisulfite for dissolving the pesticide in water to form an apparent solution. In some embodiments, the apparent solution is used for applying to agricultural crops.

According to embodiments of yet another aspect of the invention there is provided a method of solubilizing hydrophobic pesticides having one or more carbonyl groups including adding a hydrophilic compound containing an amine group for dissolving the pesticide in water to form an apparent solution.

### DESCRIPTION OF EMBODIMENTS OF THE PRESENT INVENTION

Aldehydes have properties that are diverse and that depend on the remainder of the molecule. Smaller aldehydes are more soluble in water, formaldehyde and acetaldehyde completely so, but solubility falls with chain length. In order to increase the solubility of the aldehyde molecule, one may use the reactivity of the carbonyl group therein. Aldehydes are highly reactive and participate in many reactions. From the biological perspective, the key reactions involve addition of nucleophiles to the carbonyl carbon. For example, a reaction with an amine, a cyano group, sodium bisulfite and the like. Aldehydes typically form water soluble bisulfite adducts with NaHSO3, a method which can assist dissolution of hydrophobic aldehydes in water.

More specifically, the carbonyl group of aldehydes can react with the primary amine of free amino acids to form what is known as aldimine, in which the nitrogen atom of the amine binds directly with the carbon atom of the carbonyl forming a double bond. This reaction product, also known as Schiff base, is however unstable and the carbonyl and amine can be recovered. See for example, PNAS Mar. 18, 1997, vol. 94 no 6 2106-2110: “Virtual combinatorial libraries: Dynamic generation of molecular and supramolecular diversity by self-assembly” by Ivan Huc and Jean-Marie Lehn.

### Production of Aldimines for Solubilizing Aldehydes

Aldimines, sometimes referred to as Schiff bases, are produced by reacting primary amine with aldehyde often under a specific range of pH values.

As can be seen in reaction 1, Schiff bases, on the right hand side of the reaction, produced as a result of a reaction of aldehydes with amines, and in this particular case a hydrophilic amino acid, might prove to be multifunctional agents in environmental applications. Turning otherwise sparingly soluble agents such as components of essential oils (e.g. salicylaldehyde, vanillin, ortho vanillin, benzaldehyde and cinamaldehyde) into more water soluble molecules, which are still capable of reverting to their original form, and as having enhanced solubility, may be beneficial in enhancing their penetrability and furthering their mobility in biological and environmental systems. For example, soil penetrability may be enhanced, especially as a negative charge of the amine residue will tend not to promote adhesion to clays. Additionally, the reacted aldehydes may be induced into prolonged persistence as they may be slower to decompose. It is suggested that at least in some cases the activity of aldehyde residues against some pests may be enhanced by selecting an activity promoting residue attached to the primary amine (see reaction 1). In the case of reaction 1, an amino acid, glycine is combined with salicylaldehyde, to form a product, considerably more water soluble than salicylaldehyde.

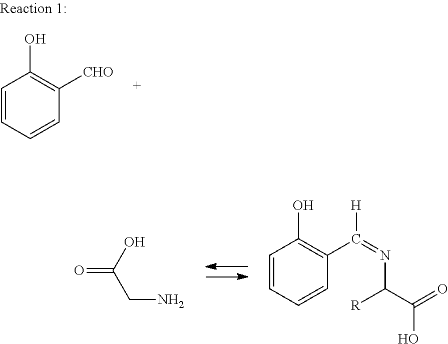

### Production of Sulfonic Acids for Solubilizing Aldehydes

As previously mentioned, Aldehydes may characteristically form “addition compounds” with sodium bisulfite (or rather the bisulfite ion). Vanillin has an aldehyde group, exhibiting typical properties of formyl. Thus, vanillin (on the left of reaction 2) combines with a salt of bisulfite, in an aqueous solvent, together with agitation, to produce the sulfonated vanillin on the right, which is considerably more water soluble than the unreacted vanillin. Likewise salicylaldehyde has an aldehyde group that readily combines with bisulfite (see reaction 3).

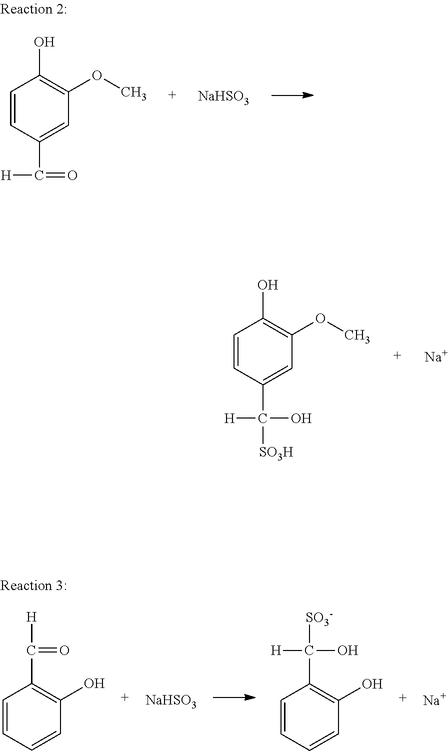

The sulfonated state of carbonyls although generally reversible is relatively stable within limits of pH and temperature, as for example discussed in U.S. Pat. No. 3,885,054 (Cohly) in column 4, line 40 onward. It is proposed that to further stabilize the sulfonated aldehydes, those aldehydes are combined with heavy metal ions to form a chelate. We have noticed that iron and copper ions form chelates as in formula 4 for vanillin. A chelate also forms with sulfonated salicylaldehyde and heavy metal ions. Sulfonated salicylaldehyde was observed to form a rather strong, red tinted chelate with Fe⁺³ in water, which was stable in a high pH environment.

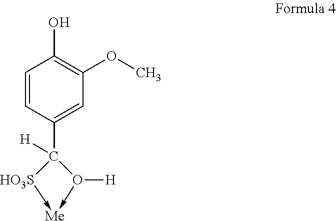

Sulfonated aldehydes might prove to be multifunctional agents in environmental applications. Turning otherwise sparingly soluble agents such as components of essential oils (e.g. salicylaldehyde, vanillin, cinamaldehyde, ortho vanillin, and benzaldehyde) into more water soluble molecules, which are capable of reverting to their original form and having enhanced solubility, may be beneficial in enhancing their penetrability and furthering their mobility in biological and environmental systems. For example, soil penetrability may be enhanced, especially as the negative charge of the sulfonic residue will tend not to promote adhesion to clays. The chelating of heavy metals may be used to promote carriage of such to combat pests, which may be affected also by the ligand itself, thereby enhancing its activity. The chelating of heavy metals may be used also to promote carriage of nutrients (sulfur and metals).

Preliminary tests were preformed to explore the effect of some compositions on red spider mite (Tetranychus urticae) on tomatoes, during the year 2012 (Omex UK Trial 2012/66). Materials used in the tests were as follows: Vanillin was mixed with sodium bisulfite, at 1:1.5 ratio (vanillin to sodium bisulfite, in weight) in 4 times the weight of vanillin in water. This mixture apparently formed a stable dark solution, referred to hereinafter as VNX. A surfactant, at the ratio of about 1:130 weight of Tergitol 15-S-7 (Dow chemicals) to the total weight of the other ingredients, was added to enhance spread.

These tests were carried out to specifically measure the effect of treatments on the survival and viability of red spider mites infecting tomato plants. The VNX sprayed at a rate, which included about 300 gram vanillin per hectare. The results obtained show that treating the plants with VNX compared to a control group (which was not treated) results in a considerable mortality of the red spider mite.

What is claimed is:

1. A composition for controlling pests comprising:
an aqueous mixture of at least one phenolic aldehyde and a bisulfite salt with a suitable surfactant, there being a sufficient amount of said bisulfite salt to solubilize said at least one aldehyde,
wherein a stable apparent solution is formed.

2. The composition as in claim 1, further including a heavy metal ion, wherein the apparent composition includes a chelated metal ion.

3. The composition as in claim 2, wherein the chelated metal ion is judged by a red tint of the apparent solution.

4. A use of a composition comprising an aqueous mixture of phenolic aldehydes and a bisulfite compound, said use for controlling pests.

5. The use according to claim 4, wherein said aldehyde is vanillin.

6. The use according to claim 4, wherein said aldehyde is salicylaldehyde.

7. A method of solubilizing hydrophobic pesticides having one or more carbonyl groups comprising: adding bisulfite for dissolving said pesticide in water to form an apparent solution.

8. The method according to claim 7, wherein said apparent solution is used for applying to agricultural crops.
